(19) United States
(12) Patent Application Publication
(10) Pub. No.: US 2022/0134293 A1
(43) Pub. Date: May 5, 2022

(54) LOW METAL CONTENT POLYOLEFIN FILTER MEMBRANE

(71) Applicant: ENTEGRIS, INC., Billerica, MA (US)

(72) Inventors: Cesar Lopez Gonzalez, Lowell, MA (US); Jad Ali Jaber, Westford, MA (US)

(21) Appl. No.: 17/512,474

(22) Filed: Oct. 27, 2021

Related U.S. Application Data
(60) Provisional application No. 63/107,926, filed on Oct. 30, 2020.

(51) Int. Cl. B01D 71/26; B01D 69/02; B01D 67/00

(52) U.S. Cl. CPC B01D 71/26; B01D 2325/34; B01D 67/0006; B01D 69/02

(57) ABSTRACT

Provided are certain polyolefinic membranes which are useful as components of filters for liquid purification. Advantageously, the filter membranes of the disclosure possess greatly reduced concentrations of certain trace metals, thus making them particularly useful in the filtration of liquids used in the fabrication of microelectronic devices. In one aspect, the disclosure provides a filter membrane comprising a polyolefin, wherein said polyolefin has less than about 4 ppm total of metals chosen from titanium, aluminum, iron, zinc, and magnesium.

### CROSS-REFERENCE TO RELATED APPLICATIONS

This application claims the benefit under 35 USC 119 of U.S. Provisional Patent Application No. 63/107,926 filed Oct. 30, 2020, the disclosure of which is hereby incorporated herein by reference in its entirety.

### TECHNICAL FIELD

The present disclosure relates to filter membranes comprising polyolefins which are essentially free of metal contaminants typically found in such polymers and filters containing such membranes.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter may include a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

Many such filter membranes are comprised of polyolefins, which are generally prepared using various metal-containing catalysts. For example, certain polyolefins such as polyethylenes are prepared using Ziegler-Natta catalysts, which may contain metals such as titanium, aluminum, and magnesium. Other catalysts may include chromium or silicon. Such catalysts are thus present in small, but potentially deleterious amounts in the filter medium prepared from such polyolefins. If used as is, the filter media may allow these metals to leach out when they are being used to filter liquid compositions such as solvents. Accordingly, these filter media are typically washed in order to remove any such metal contaminants at or near the surface of the polyolefin material. Any such metals not removed during such a process thus remain entrained in the polymer matrix, and thus may potentially leach out under operational conditions. The removal of ionic materials such as dissolved metal cations from solutions is important in many industries, such as the microelectronics industry, where cationic metal contaminants in very small concentrations can ultimately adversely affect the quality and performance of microprocessors and memory devices. The ability to prepare positive and negative photoresists with low levels of metal ion contaminants, or the ability to deliver isopropyl alcohol used in Maragoni drying for wafer cleaning with low part per billion or part per trillion levels of metal ion contaminants is highly desirable and are just two examples of the needs for contamination control in semiconductor manufacturing. Thus, there remains a need for improved methods of filtration of liquid compositions where the presence of such metal ions is reduced or effectively eliminated.

### SUMMARY

In summary, the disclosure provides certain polyolefinic membranes which are useful as components of filters for liquid purification and/or filtration. In one embodiment, the polyolefins are chosen from polyethylene and copolymers such as polyethylene and polyethylene-co-polybutylene. Advantageously, the filter membranes of the disclosure possess greatly reduced concentrations of certain trace metals, thus making them particularly useful in the filtration of liquids used in the fabrication of microelectronic devices. In one aspect, the disclosure provides a filter membrane comprising a polyolefin, wherein the sum of the amount of titanium, aluminum, iron, zinc, and magnesium in the polyolefin is less than about 4 ppm, as determined by MARS 6 Microwave Acid Digestion Method Note Compendium.

### BRIEF DESCRIPTION OF THE DRAWINGS

The disclosure may be more completely understood in consideration of the following description of various illustrative embodiments in connection with the accompanying drawings

FIG. 1 (which is schematic and not necessarily to scale) shows an example of a filter product as described herein.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

The amount of trace metals present in the polyolefins is measured using the method described in “MARS 6 Microwave Acid Digestion Method Note Compendium”, Microwave Digestion of polyethylene-High density p 511. CEM corporation. Oct. 1, 2019. Website: https://cem.com/media/contenttype/media/literature/MetNote_MARS6_Compendium_2.pdf After microwave digestion, the sample was diluted approximately 50 times using deionized (DI) water to test the metal concentration using inductively coupled plasma mass spectrometry (ICP-MS).

In a first aspect, the disclosure provides a filter membrane comprising a polyolefin, wherein the sum of the amount of titanium, aluminum, iron, zinc, and magnesium in the polyolefin is less than about 4 ppm, as determined by MARS 6 Microwave Acid Digestion Method Note Compendium. This total level of metals is based on μg of total metals per gram of polyolefin resin. In other embodiments, the polyolefin has less than about 3.5 ppm, or less than about 3 ppm, or less than about 2 ppm, or less than about 1 ppm total of metals chosen from titanium, aluminum, iron, zinc, and magnesium.

In another embodiment, the polyolefin has less than about 1 ppm of ruthenium. In one embodiment, the sum of titanium, aluminum, silicon, chromium, and magnesium in the polyolefin is greater than 0.1 ppm, and greater than 0.1 ppm of ruthenium, and less than the above stated amounts.

In one embodiment, the polyolefins are chosen from polyethylenes and polyethylene copolymers. Exemplary polyolefins include polyethylene and copolymers such as polyethylene-co-polybutylene. The physical properties of copolymers such as polyethylene-co-polybutylene are similar to commercial polyethylene. In one embodiment, the polyolefin is a polyethylene. In another embodiment, the polyethylene-co-polybutylene has a number average molecular weight of about 330,000 to 2,200,000 Daltons. In another embodiment, the polyethylene and polyethylene-co-polybutylene have a number average molecular weight of about 700,000 Daltons to about 1,500,000 Daltons. In another embodiment, the polyolefin is an ultra-high molecular weight polyethylene.

The filter membranes of the first aspect can be comprised of polyethylene which can be prepared by a ring-opening metathesis polymerization (ROMP) reaction of 1-octene with a Ruthenium II catalyst. For example, according to the following scheme:

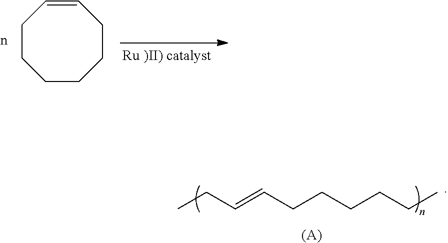

In the above reaction, a Ruthenium II catalyst is utilized in a ring-opening metathesis polymerization (ROMP) reaction to provide the unsaturated polymer of formula (A)(i.e., a polyethylene). The reaction is generally conducted in a non-polar aprotic solvent such as hexanes, dichloromethane, chloroform, toluene, diethyl ether, ethyl acetate, and the like, and can be conducted at room temperature or slightly elevated temperatures, for example from about 23° C. to about 70° C. In one embodiment, the Ru II catalyst is one which possesses a functional group which renders the catalyst water-soluble or water-dispersible, thus facilitating its removal during product work-up using ordinary aqueous extraction. Such functional groups include, for example, ammonium groups, quaternary ammonium groups, amines, a polyalkylene glycol, or like functional group which enable the catalyst to be effectively removed from an organic solution of the polymer of formula (A) by an aqueous solution (acidic or basic pH), removed by continuous precipitation, Soxhlet extraction, or adsorption on silica, or adsorption on ion exchange or chelating resins. Alternately, the Ruthenium II catalyst can be one which is tethered to a solid support as an alternate means for separating the catalyst from the reaction product mixture, and thus reducing or effectively eliminating ruthenium contamination in the resulting polyolefin.

Examples of suitable Ruthenium II catalysts include those known as Grubbs catalysts and Hoveyda-Grubbs Second Generation catalysts. Suitable metathesis catalysts include those available from Apeiron Synthesis. Particular catalysts include:
i. (1,3-Bis(2,6-diisopropylphenyl)-4-((4-ethyl-4-methylpiperzain-1-ium-1-yl)methyl)imidazolidin-2-ylidene)(2-isopropoxybenzylidene)ruthenium(II) chloride dihydrate; (“FixCat”);
ii. (1,3-dimesityl-4-((trimethylammonio)methyl)imidazolidin-2-ylidene)dichloro(2-isopropoxybenzylidene)ruthenium(II) Cloride; (“StickyCat Cl”);
iii. (4-((4-Ethyl-4-methylpiperazin-1-ium-1-yl)methyl)-1,3-dimesitylimidazolidin-2-ylidene)dichloro(2-isopropoxybenzylidene)ruthenium(II) chloride (“AquaMet”)
iv. (1,3-dimesityl-4-((trimethylammonio)methyl)imidazolidin-2-ylidene)dichloro(2-isopropoxybenzylidene)ruthenium(II) hexafluorophosphate; (“StickyCat PF6”); and
v. (1,3-dimesityl-4-((trimethylammonio)methyl)imidazolidin-2-ylidene)dichloro(2-isopropoxybenzylidene)ruthenium(II) tetrafluoroborate; (“StickyCat BF4”).

The reaction is generally conducted for a period of about 0.3 to about 4 hours, and then chain cleavage is done using a vinyl ether such as ethyl vinyl ether, ethylene glycol vinyl ether, di(ethylene glycol) vinyl ether, or di(ethylene glycol) divinyl ether.

The then-purified solution of the unsaturated polymer of formula (A) may be reduced using a hydrazine-type or hydrazido-type reducing agent such as p-toluene sulfonyl hydrazide, in the presence of an amine such as tripropyl amine, to provide a saturated polyethylene compound represented b formula (B:

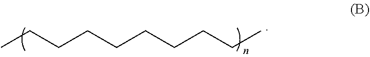

Accordingly, in another aspect, the disclosure provides the above membranes, wherein the polyolefin is prepared by:

A. contacting cis- or trans-cyclooctene with a Ru II catalyst, followed by

B. removal or extraction of the Ru II catalyst, followed by

C. hydrogenation with a hydrazine-type or hydrazido-type reducing agent.

Alternately, the polyolefin of the first aspect can be prepared by reducing commercially-available polybutadiene (CAS No. 9003-17-2). Such reductions (i.e., hydrogenation) can be accomplished by use of a hydrazine-type or a hydrazido-type reducing agent such as p-toluenesulfonyl hyrazide (available from Sigma-Aldrich, CAS No. 576-35-8), in the presence of an amine such as tributylamine. Other suitable reducing agents include benzenesulfonyl hydrazide; 2,4,6-triisopropylbenzenesulfonyl hydrazide; 2,4,6-trimethylbenzenesulfonohydrazide; N,N′-bis(p-toluenesulfonyl)hydrazine; and the like. Thus, compounds of the formula (C) can be prepared according to the following scheme. Compounds of formula (C) are referred to as polyethylene-co-polybutylene.

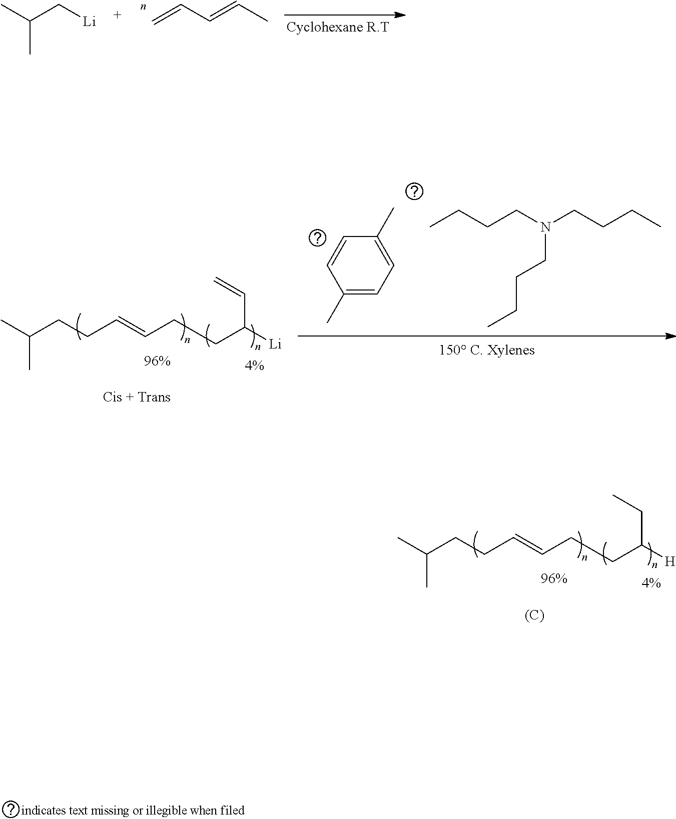

Accordingly, in another aspect, the disclosure provides the above membranes, wherein the polyolefin is prepared by contacting polybutadiene with hydrogen in the presence of a hydrazido-type or hydrazine-type reducing agent.

The polyolefins of formulae (B) and (C) will in one embodiment have a number molecular weight (Mₙ) of about 330 K Daltons to about 2.2 M Daltons, or about 700 K Daltons to about 1.5 M Daltons, or about 1.1 M Daltons.

The polyolefins of formulae (B) and (C) can then be utilized in the fabrication of filter membranes for use in various filter structures. A suitable process for preparing a porous filter membrane as described can be a method sometimes referred to as an extrusion melt-cast process, or as “thermally-induced liquid-liquid phase separation.” In this type of process, the polymer is dissolved at elevated temperature (“extrusion temperature”) in a combination of two or more solvents to form a heated polymer solution that can be processed and shaped, e.g., through an extruder. The heated polymer solution can be passed through an extruder and an extrusion die, to be shaped, such as into the form of a sheet-like membrane. The heated polymer solution is passed through the die and is dispensed onto a shaping surface that is at a temperature that is much lower than the extrusion temperature, i.e., a “cooling temperature.” When the extruded, heated polymer solution contacts the lower-temperature shaping surface, the polymer and solvents of the heated polymer solution undergo one or more phase separations in a manner that causes the polymer to be formed into a porous filter membrane as described herein. Examples of comparable processes of producing porous polymeric shaped materials are described, for example, in U.S. Pat. No. 6,497,752, the entirety of which is incorporated herein by reference.

A filter membrane as described can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the composite filter membrane within the filter assembly or filter cartridge to cause fluid to flow from a filter inlet, through the composite membrane (including the filter layer), and thorough a filter outlet, thereby passing through the composite filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

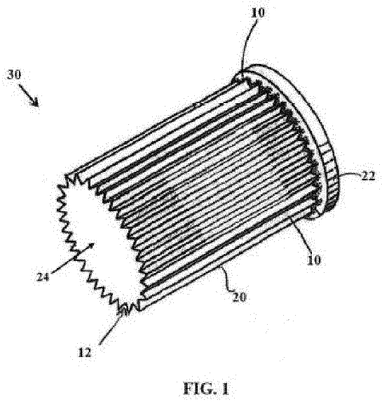

As one example, FIG. 1 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through filtration membrane 12 before exiting the filter at the outlet.

### EXAMPLES

Materials:

All materials were used as received. Dichloromethane 99.6%, cis-cyclooctene 95% from Alfa Aesar. Chloroform 99.8% from Merck KgaA. (4-((4-Ethyl-4-methylpiperazin-1-ium-1-yl)methyl)-1,3-dimesitylimidazolidin-2-ylidene)dichloro(2-isopropoxybenzylidene)ruthenium(II) chloride (AquaMet) >99%, ((1,3-Bis-(2,4,6-trimethylphenyl)-2-imidazolidinylidene)dichloro(o-isopropoxyphenylmethylene)ruthenium, Hoveyda-Grubbs Catalyst® M72 >97%, decahydronaphthalene mixture of cis and trans, anhydrous >99%, 1,4-Bis(3-isocyanopropyl)piperazine (SnatchCat) >95%, 2,6-di-tert-butyl-4-methylphenol >99.0%, ethyl vinyl ether, 99%, ethylene glycol vinyl ether, 97%, hydrochloric acid (HCl) 37%, p-toluenesulfonyl hydrazide >97%, tripropylamine >98%, xylenes >98.5% from Sigma Aldrich. Isopropyl alcohol (IPA) gigabit grade KMG, hexanes 98.5% from VWR. ([1,3-Bis(2,4,6-trimethylphenyl)-4-[(trimethylammonio)methyl]imidazolidin-2-ylidene]-(2-i-propoxybenzylidene)dichlororuthenium(II) chloride) (Stickycat Cl) >99% from Strem Chemicals. Polybutadiene from Polysource (P10053-Bd, Mₙ=1200 k Daltons, Ð=1.18). Tetramethyl ammonium hydroxide (25% in H₂O) from J.T. Baker. Silica gel for column chromatography 40 um-60 um, average pore size 60 Å from Acros organics. SiliaMetS Thiol (SH) Metal Scavenger (R51030B) (pore size 60 Å) from Silicycle. Puromet MTS9100 (amidoxime) from Purolite and NRW160 resins from Purolite. Cellulose filter paper No 42 ashless circles 90 mm from Whatman.™ PTFE-based beakers, separatory funnels and vials.

Analytical Methods:

The samples were analyzed following the method described on “MARS 6 Microwave Acid Digestion Method Note Compendium”, Microwave Digestion of polyethylene-High density p 511. CEM corporation. Oct. 1, 2019. Website: https://cem.com/media/contenttype/media/literature/MetNote_MARS6_Compendium_2.pdf

After microwave digestion, the sample was diluted approximately 50 times using deionized (DI) water to test the metal concentration using inductively coupled plasma mass spectrometry (ICP-MS).

The polymer molecular weight was determined using gel permeation chromatography (GPC) coupled with an Agilent 1260 refractive index detector. Data acquisition and handling was made with Jordi GPC software. Data was obtained under the following conditions: Solvent: Chloroform. Columns: Jordi Resolve DVB MB+500 Å, 300×7.8 mm, calibrated with polystyrene standards 6.57M, 3.152M, 885K, 479.2K, 194.5K, 75.05K, 22.29K, 10.33K, 4.88K, 1.21K, 580 & 162 Da. Flow rate: 1.0 mL/min.

Samples were analyzed in a Bruker 75 MHz ¹³C melt-state NMR at 150° C. under a MAS frequency of 2.5 kHz. Each experimental time was 18 hours. Exponential window function of the spectra was 3 Hz (S/N>1000).

Elemental analysis was determined using a Perkin-Elmer 2400 with an oxygen accessory kit.

Melting temperatures were determined using a Perkin Elmer diamond differential scanning calorimeter (DSC).

### Example 1

This example demonstrates the synthesis of polyoctene, expected Mₙ=2200 k Daltons.

In a representative experiment, a solution of 11.8 mL of cis-cyclooctene in 180 mL of chloroform was added dropwise to a solution of 3.3 mg of Stickycat Cl in 3 mL of chloroform for 60 min.

Then, 100 mL of chloroform was added and the solution was heated to 40° C. for 4 h. Then, added 2.5 mL of ethyl vinyl ether all at once and stirred for 0.5 h at 40° C.

After that, the organic phase was extracted with 50 mL of an acidic solution HCl (10%) made with 68.2 mL of HCl (37%) in 181 mL of DI water 5 times. For every extraction, 0.2 mL of ethyl vinyl ether was added to the organic phase and the solution was stirred for 20 min after each extraction.

After the extractions, the solution was poured into 200 mL of isopropyl alcohol. A white polymer precipitated. The mother liquor was decanted and the polymer was dried in a convection oven for 16 h at room temperature (9.90 g, 99.0% yield). The metal concentration was determined using microwave digestion and ICP-MS.

Al=0.0 ppm, Mg=0.0 ppm, Ti=0.0 ppm, Zn=0.0 ppm, Fe=0.0 ppm, Ru=5.4 ppm.
Thus, the sum of titanium, aluminum, iron, zinc, and magnesium is 0.0 ppm.

In a subsequent run of the experiment under the same conditions the polymer after being dried was 5.6 g and 56.0% yield. The metal concentration was determined using microwave digestion and ICP-MS. Al=0.00 ppm, Mg=0.00 ppm, Ti=0.28 ppm, Zn=0.00 ppm, Fe=0.05 ppm, Ru=10.39 ppm. Thus, the sum of titanium, aluminum, iron, zinc, and magnesium is 0.33 ppm.

### Example 2

This example demonstrates the synthesis of polyoctene with purification using continuous precipitations, expected Mₙ=2200 k Daltons.

In a representative experiment, a solution of 11.8 mL of cis-cyclooctene in 180 mL of chloroform was added dropwise to a solution of 3.3 mg of Stickycat Cl in 3 mL of chloroform for 60 min.

Then, added 100 mL of chloroform and the solution was heated to 40° C. for 4 h. Then, added 2.5 mL of ethyl vinyl ether all at once and stirred for 0.5 h at 40° C.

The organic solution was poured into 300 mL of IPA, a white polymer precipitated.

The liquid was decanted and the white polymer was dried in a convection oven at room temperature for 10 h. Then, the polymer was re-dissolved in 180 mL in dichloromethane at 30° C. and re-precipitated 3 times using the described amounts of IPA.

Then, the polymer was dried in a convection oven for 16 h at room temperature (9.20 g, 92% yield). The metal concentration was determined using microwave digestion and ICP-MS. Al=0.0 ppm, Mg=0.0 ppm, Ti=0.4 ppm, Zn=0.1 ppm, Fe=0.1 ppm, Ru=0.6 ppm. Thus, the sum of titanium, aluminum, iron, zinc, and magnesium is 0.6 ppm.

In a subsequent run of the experiment under the same conditions the polymer after being dried was 4.2 g and 42% yield. The metal concentration was determined using microwave digestion and ICP-MS. After a first precipitation the metal concentration was Al=0.00 ppm, Mg=0.00 ppm, Ti=0.00 ppm, Zn=0.00 ppm, Fe=11.46 ppm, Ru=3.88 ppm. After a second precipitation the metal concentration was Al=0.00 ppm, Mg=0.00 ppm, Ti=0.00 ppm, Zn=0.00 ppm, Fe=0.00 ppm, Ru=2.98 ppm. Thus, the sum of titanium, aluminum, iron, zinc, and magnesium is 0.00 ppm.

### Example 3

This example demonstrates the synthesis of polyoctene, expected Mₙ=330 k Daltons.

In a representative experiment, a solution of 177 mL of cis-cyclooctene in 2950 mL of chloroform was added dropwise to a solution of 333 mg of Stickycat Cl in 43 mL of chloroform for 35 min.

The solution was heated to 40° C. for 6 h. Then, added 8 mL of ethylene glycol vinyl ether all at once and stirred for 4 h at room temperature.

The viscous solution was extracted with 3 L of DI water 5 times. Added 8 mL of ethylene glycol vinyl ether to the organic phase and the solution was stirred for 20 min after each extraction.

After the extractions, the solution was poured into 6 L of IPA. A white polymer precipitated. The mother liquor was decanted and the polymer was dried in a convection oven for 16 h at room temperature (146 g, 97% yield). The metal concentration was determined using microwave digestion and ICP-MS. Al=2.7 ppm, Mg=0.3 ppm, Ti=0.0 ppm, Zn=0.3 ppm, Fe=0.0 ppm, Ru=42.1 ppm. Thus, the sum of titanium, aluminum, iron, zinc, and magnesium is 3.3 ppm.

In a subsequent run of the experiment under the same conditions the polymer after being dried was 129 g and 86% yield. GPC (Mn=132.2 k Daltons, Mw=202.8 k Daltons, Ð=1.5).

### Example 4

This example demonstrates the synthesis of polyoctene, expected Mₙ=1100 k Daltons.

In a representative experiment, a solution of 5.9 mL of cis-cyclooctene in 50 mL of dichloromethane was added dropwise to a solution of 3.5 mg of Aquamet in 2 mL of dichloromethane for 4 min.

The solution was heated to 36° C. for 30 min and a viscous solution was obtained. Then, added 200 mL of hexanes and heated to 50° C. for 3 h. After that, added 2 mL of ethylene glycol vinyl ether all at once and stirred for 4 h at room temperature.

The organic solution was poured into 200 mL of IPA, a white polymer precipitated.

The liquid was decanted and the white polymer was dried in a convection oven at room temperature for 10 h. Then, the polymer was re-dissolved in 300 mL in dichloromethane at 30° C.

The viscous solution was extracted with 20 mL of DI water 5 times. After the extractions, the solution was poured into 200 mL of IPA. A white-pale brown polymer precipitated. The mother liquor was decanted and the polymer was dried in a convection oven for 16 h at room temperature (4.5 g, 90% yield). The metal concentration was determined using microwave digestion and ICP-MS. Al=0.9 ppm, Mg=0.7 ppm, Ti=0.0 ppm, Zn=0.0 ppm, Fe=0.0 ppm, Ru=2.4 ppm. Thus, the sum of titanium, aluminum, iron, zinc, and magnesium is 1.6 ppm.

In a subsequent run of the experiment under the same conditions the polymer after being dried was 3.5 g and 70% yield. The metal concentration was determined using microwave digestion and ICP-MS and was Al=0.00 ppm, Mg=0.00 ppm, Ti=0.00 ppm, Zn=0.00 ppm, Fe=0.00 ppm, Ru=11.62 ppm. Thus, the sum of titanium, aluminum, iron, zinc, and magnesium is 0.00 ppm.

### Example 5: (Prophetic)

This example demonstrates the synthesis of polyoctene with purification using silica gel adsorption, expected Mₙ=5500 k Daltons.

In a representative experiment, add a solution of 11.8 mL of cis-cyclooctene in 170 mL of chloroform dropwise to a solution of 1.3 mg of Stickycat Cl in 3 mL of chloroform for 60 min.

Then, add 100 mL of chloroform and heat the solution to 40° C. for 4 h. Subsequently, add 2.5 mL of ethyl vinyl ether all at once and stir for 0.5 h at 40° C.

After that, add 2 g of silica gel and stir the solution for 30 min. Then, filter the silica using filter paper under vacuum (approx. 150 mbar). Wash the silica with 150 mL of dichloromethane at 36° C. Repeat the silica gel addition and filtration.

Then, extract the viscous solution with 100 mL of an acidic solution HCl (10%) made with 81 mL of HCl (37%) in 219 mL DI water three times.

After the extractions, pour the solution into 300 mL of isopropyl alcohol to precipitate a white polymer. Then, decant the mother liquor and dry the precipitate in a convection oven for 16 h at room temperature.

### Example 5A

This example demonstrates the synthesis of polyoctene and purification using silica gel adsorption.

In a representative experiment, a solution of 11.8 mL of cis-cyclooctene was added dropwise to a solution of 1.3 mg of Stickycat Cl in 3 mL of chloroform over 30 min.

Then, 280 mL of chloroform was added heat the solution was to 60° C. for 12 h. After that, 2.5 mL of ethyl vinyl ether and 10 mg of Snatchcat were added all at once. Then, the solution was stirred for 0.5 h at 40° C.

After that, 2.0 g of silica gel was added to the solution and stirred for 2 h at 40° C. The silica was filtered using filter paper under vacuum (approx. 150 mbar). The silica was washed with chloroform at room temperature. The addition of 2.0 g of silica and filtration was repeated with the filtrate.

Then, the organic phase was extracted with 100 mL of an acidic solution HCl (10%) made with 81 mL of HCl (37%) in 219 mL DI water three times.

After the extractions, the organic solution was poured into 300 mL of isopropyl alcohol and the polymer precipitated. Then, the liquid was decanted. The solid was collected and dried in a convection oven for 16 h at room temperature. (3.5 g, 35.0% yield). GPC (Mn=486.1 k Daltons, Mw=1311.2 k Daltons, Ð=2.7). The metal concentration was determined using microwave digestion and ICP-MS. Al=0.83 ppm, Ti=0.32 ppm, Zn=0.37 ppm, Fe=2.42 ppm, Ru=2.40 ppm. Thus, the sum of titanium, aluminum, iron, zinc, magnesium and other metals is 3.94 ppm.

### Example 6: (Prophetic)

This example demonstrates the synthesis of polyoctene with purification using basic extractions with tetramethyl ammonium hydroxide, expected Mₙ=1100 k Daltons.

In a representative experiment, add a solution of 11.8 mL of cis-cyclooctene in 180 mL of chloroform dropwise to a solution of 6.7 mg of Stickycat Cl in 3 mL of chloroform for 60 min.

Then, add 100 mL of chloroform and heat the solution was to 40° C. for 4 h. Then, add 2.5 mL of ethyl vinyl ether all at once and stir for 0.5 h at 40° C.

Prepare a solution of NCH₄OH (5%) with 30 mL of NCH₄OH (25% in H₂O) in 120 mL of DI water. Then, extract the organic phase with 50 mL of NCH₄OH (5%) solution alternating with 50 mL of DI water 3 times.

After the extractions, pour the solution in 200 mL of IPA to precipitate a white polymer. Then, decant the liquid and dry the polymer in a convection oven for 16 h at room temperature.

### Example 6A

This example demonstrates the synthesis of polyoctene with purification using basic extractions with tetramethyl ammonium hydroxide, expected Mₙ=1100 k Daltons.

In a representative experiment, a solution of 11.8 mL of cis-cyclooctene in 180 mL of chloroform was added dropwise to a solution of 6.7 g of Stickycat Cl in 3 mL of chloroform over 60 min.

Then, 100 mL of chloroform was added heat the solution was to 60° C. for 4 h. After that, 2.5 mL of ethyl vinyl ether and 10 mg of Snatchcat were added all at once and the solution was stirred for 0.5 h at 40° C.

After that, a solution of NCH₄OH (5%) was made with 30 mL of NCH₄OH (25% in H₂O) in 120 mL of DI water. Then, the organic phase was extracted with 50 mL of NCH₄OH (5%) solution alternating with 50 mL of DI water 3 times.

After the extractions, the organic solution was poured into 200 mL of IPA and a white polymer precipitated. Then, the liquid was decanted. The solid was collected and dried in a convection oven for 16 h at room temperature. (4.13 g, 41.3% yield).

The metal concentration was determined using microwave digestion and ICP-MS. Al=2.96 ppm, Mg=0.00 ppm, Ti=0.00 ppm, Zn=0.00 ppm, Fe=0.78 pm, Ru=4.03 ppm. Thus, the sum of titanium, aluminum, iron, zinc, and magnesium was 3.74 ppm.

### Example 7: (Prophetic)

This example demonstrates the synthesis of polyoctene with purification using Soxhlet extractions in IPA, expected Mₙ=2200 k Daltons.

In a representative experiment, add solution of 11.8 mL of cis-cyclooctene in 180 mL of chloroform dropwise to a solution of 3.3 mg of Stickycat Cl in 3 mL of chloroform for 60 min.

Then, add 100 mL of chloroform and heat the solution to 40° C. for 4 h. Then, add 2.5 mL of ethyl vinyl ether all at once and stir for 0.5 h at 40° C.

Pour the organic solution into 300 mL of IPA to precipitate a white polymer.

Decant the liquid and dry the white polymer in a convection oven at room temperature for 10 h. Then, put the polymer in a Soxhlet apparatus covered in non-woven membrane and extract continuously using IPA for 72 h.

Subsequently, dry the polymer in a convection oven for 16 h at room temperature.

### Example 7A

This example demonstrates the synthesis of polyoctene with purification using Soxhlet extractions in IPA, expected Mₙ=2200 k Daltons.

In a representative experiment, a solution of 11.8 mL of cis-cyclooctene in 180 mL of chloroform was added dropwise to a solution of 3.2 g of Stickycat Cl in 3 mL of chloroform over 60 min.

Then, 100 mL of chloroform was added heat the solution was to 60° C. for 4 h. After that, 2.5 mL of ethyl vinyl ether was added all at once and the solution was stirred for 0.5 h at 40° C.

After that, the organic solution was poured into 200 mL of IPA and a white polymer precipitated. Then, the liquid was decanted. The solid was collected, covered with non-woven membrane and introduced into a Soxhlet apparatus. Then, the polymer was extracted in the Soxhlet apparatus continuously using IPA for 72 h.

Subsequently, the polymer was dried in a convection oven for 16 h at room temperature (3.6 g, 36% yield). The metal concentration was determined using microwave digestion and ICP-MS. Al=0.00 ppm, Mg=0.00 ppm, Ti=0.26 ppm, Zn=0.00 ppm, Fe=0.00 pm, Ru=24.24 ppm. Thus, the sum of titanium, aluminum, iron, zinc, and magnesium was 0.26 ppm.

### Example 8

This example demonstrates the synthesis of polyethylene by reducing polyoctene in example 4.

In a representative experiment, 1.00 g of polyoctene (Mₙ=1100 k Daltons) was dissolved in 110 mL xylenes. Then, the mixture was heated to 110° C.

To the reaction mixture, 6.78 g of p-toluene sulfonylhydrazide was added all at once. Subsequently, 4.7 mL of tripropyl amine was added all at once. The reaction was heated to 150° C. and stirred under reflux for 7 h.

Then, cooled down to 135° C. and poured in 300 mL of IPA all at once. A white precipitate was formed. The polymer was filtered on a filter paper and washed with 40 mL of acetone.

The polymer was dried in a convection oven for 24 h. (0.93 g, 89% yield).

Melting point 130.2° C.-134.5° C.

¹³C melt state NMR at 150° C. determined double bond concentration of 2.72% in the sample. Elemental analysis determined C=83.68% H=14.79% (molar ratio H to C=2.11).

### Example 9

This example demonstrates the purification of polybutadiene with acid extractions.

In a representative experiment, 1.00 g of polybutadiene (Mₙ=1200 k Daltons, Ð=1.18) was dissolved in 100 mL of hexanes. The organic solution was extracted with 100 mL of an acidic solution HCl (10%) made with 137 mL of HCl (37%) in 363 mL of DI water 5 times.

The solution was precipitated in 100 mL of IPA. The polymer precipitated from solution and was filtered on a filter paper. The polymer was dried for 24 h in a convection oven at room temperature.

The polybutadiene contained <100 ppb total metal concentration including titanium, aluminum, iron, zinc, and magnesium.

### Example 10

This example demonstrates the synthesis of polyethylene copolymers such as polyethylene-co-polybutylene resins by reduction of double bonds of polybutadiene.

In a representative experiment, after performing the purification described in example 9, 1.00 g of polybutadiene (Mₙ=1200 k Daltons, Ð=1.18) was dissolved in 50 mL xylenes, then added 10 mg of 2,6-di-tert-butyl-4-methylphenol. Then, the mixture was heated to 110° C.

To the reaction mixture, 12.03 g of p-toluenesulfonyl hydrazide was added all at once. Subsequently, 8.5 mL of tripropylamine was added all at once. The reaction was heated to 150° C. and stirred under reflux for 6 h.

The reaction mixture was cooled down to 135° C. and poured in 50 mL of IPA all at once. A white precipitate was formed. The polymer was filtered using a filter paper. The solid was dried in a convection oven for 24 h. (0.83 g, 83% yield).

The polymer was re-dissolved in in 50 mL decahydronaphthalene at 150° C. and poured into 200 mL of IPA all at once at room temperature. The precipitation repeated twice. The polymer was filtered using a filter paper and dried in a convection oven for 24 h.

¹³C melt state NMR at 150° C. determined double bond concentration of 3.48% in the sample. Elemental analysis determined C=81.71% H=13.65% (molar ratio H to C=1.99). Melting point=109.0° C.

### Example 11: (Prophetic)

This example demonstrates the synthesis of polyethylene by reducing polyoctene, expected Mₙ=5600 k Daltons.

In a representative experiment, add 10 mg of mg of 2,6-di-tert-butyl-4-methylphenol to a solution of 1.00 g of polyoctene (Mₙ=5500 k Daltons) in 100 mL xylenes. Then, heat the mixture to 110° C.

To the reaction mixture, add 6.8 g of p-toluene sulfonyl hydrazide all at once. Subsequently add 4.8 mL of tripropylamine all at once. Heat the reaction to 150° C. and stir under reflux for 6 h.

After that, cool down the reaction mixture to 135° C. and pour it into 100 mL of IPA all at once to precipitate the polymer. Then, filter the polymer using a filter paper and dry the solid in a convection oven for 24 h.

### Example 12

This example demonstrates the synthesis of polyoctene and purification using silica gel adsorption.

In a representative experiment, a solution of 11.8 mL of cis-cyclooctene in 180 mL of chloroform was added dropwise to a solution of 3.2 mg of Stickycat Cl in 3 mL of chloroform over 60 min.

Then, 100 mL of chloroform was added heat the solution was to 60° C. for 4 h. After that, 2.5 mL of ethyl vinyl ether and 10 mg of Snatchcat were added all at once and the solution was stirred for 0.5 h at 40° C.

After that, 5.0 g of silica gel was added to the solution and stirred for 2 h at 40° C. The silica was filtered using filter paper under vacuum (approx. 150 mbar). The silica was washed with chloroform at room temperature.

Then, the organic phase was extracted with 100 mL of an acidic solution HCl (10%) made with 81 mL of HCl (37%) in 219 mL DI water three times.

After the extractions, the organic solution was poured into 300 mL of isopropyl alcohol and a white polymer precipitated. Then, the liquid was decanted. The solid was collected and dried in a convection oven for 16 h at room temperature. (3.56 g, 35.6% yield). GPC (Mn=212.0 k Daltons, Mw=430.3 k Daltons, Ð=2.0). The metal concentration was determined using microwave digestion and ICP-MS. Al=1.01 ppm, Mg=0.00 ppm, Ti=0.22 ppm, Zn=0.36 ppm, Fe=1.54 pm, Ru=0.19 ppm. Thus, the sum of titanium, aluminum, iron, zinc, and magnesium was 3.13 ppm.

### Example 13

This example demonstrates the synthesis of polyoctene using Stickycat Cl immobilized on silica gel previous to the polymerization.

In a representative experiment, Stickycat Cl was immobilized on silica gel prior to reaction. The silica gel was dried in a convection oven at 150° C. for 12 h and cooled too room temperature in a chamber under vacuum before use.

A solution of 3.2 mg of Stickycat Cl in 2 mL of CHCl₃ was added to 0.64 g of dried silica gel. Then, the silica gel was dried in the rotatory evaporator.

Then, a solution of 11.8 mL of cis-cyclooctene in 180 mL of chloroform was added dropwise to the immobilized Stickycat Cl on silica gel for 60 min. The heterogeneous reaction was vigorously stirred.

Then, 100 mL of chloroform was added heat the solution was to 60° C. for 4 h. After that, 2.5 mL of ethyl vinyl ether and 10 mg of Snatchcat were added all at once and the suspension was stirred for 0.5 h at 40° C. Then, the silica gel was filtered using filter paper under vacuum (approx. 150 mbar). The silica was washed with chloroform at room temperature.

Then, the organic phase was extracted with 100 mL of an acidic solution HCl (10%) made with 81 mL of HCl (37%) in 219 mL DI water three times.

After the extractions, the organic solution was poured into 300 mL of isopropyl alcohol and a white polymer precipitated. Then, the liquid was decanted. The solid was collected and dried in a convection oven for 16 h at room temperature. (2.10 g, 21.0% yield). GPC (Mn=591.2 k Daltons, Mw=1703.9 k Daltons, Ð=2.9).

### Example 14: (Prophetic)

This example demonstrates the synthesis of polyoctene using Stickycat Cl immobilized on silica gel (SiliaMetS Thiol (SH) Metal Scavenger (R51030B)) previous to the polymerization, expected Mₙ=2300 k Daltons.

In a representative experiment, immobilize the Stickycat Cl on silica gel (SiliaMetS Thiol (R51030B)) prior to the reaction.

Then, add a solution of 3.2 mg of StickyCat Cl in 2 mL of CHCl₃ to 0.64 g of silica gel (SiliaMetS Thiol (R51030B)). Then, dry the silica gel in the rotatory evaporator.

Then, add a solution of 11.8 mL of cis-cyclooctene in 180 mL of chloroform dropwise to the immobilized Stickycat Cl on silica gel (SiliaMetS Thiol (R51030B)) for 60 min and stir vigorously.

Then, add 280 mL of chloroform and heat the solution to 40° C. for 4 h. Subsequently, add 2.5 mL of ethyl vinyl ether all at once and stir for 0.5 h at 40° C.

Then, filter the silica using filter paper under vacuum (approx. 150 mbar). Wash the silica with 150 mL of dichloromethane at room temperature.

Then, extract the viscous solution with 100 mL of an acidic solution HCl (10%) made with 81 mL of HCl (37%) in 219 mL DI water three times.

After the extractions, pour the solution into 300 mL of isopropyl alcohol to precipitate a white polymer. Then, decant the mother liquor and dry the precipitate in a convection oven for 16 h at room temperature.

### Example 15: (Prophetic)

This example demonstrates the synthesis of polyoctene and purification using chelating resin (Puromet MTS9100), expected Mₙ=5500 k Daltons.

In a representative experiment, add a solution of 11.8 mL of cis-cyclooctene dropwise to a solution of 1.3 mg of Stickycat Cl in 3 mL of chloroform for 60 min.

Then, add 100 mL of chloroform and heat the solution to 60° C. for 12 h. Subsequently, add 2.5 mL of ethyl vinyl ether all at once and stir for 0.5 h at 40° C.

After that, take and aliquot of 6 mL and add it to 0.2 g of resin (Puromet MTS9100) and stir for 24 h.

After that, decant the liquid into another vial with 20 mL of isopropyl alcohol. Stir the vial and let the polymer precipitate. Then, decant the liquid and dry the solid in a convection oven at room temperature.

### Example 16: (Prophetic)

This example demonstrates the synthesis of polyoctene and purification using an ion exchange resin (NRW160), expected Mₙ=5500 k Daltons.

In a representative experiment, add a solution of 11.8 mL of cis-cyclooctene dropwise to a solution of 1.3 mg of Stickycat Cl in 3 mL of chloroform for 60 min.

Then, add 100 mL of chloroform and heat the solution to 60° C. for 12 h. Subsequently, add 2.5 mL of ethyl vinyl ether all at once. Then, stir the solution for 0.5 h at 40° C.

After that, take and aliquot of 6 mL and add it to 0.2 g of resin (NRW160) and stir for 24 h.

After that, decant the liquid into another vial with 20 mL of isopropyl alcohol. Stir the vial and let the polymer precipitate. Then, decant the liquid and dry the solid in a convection oven at room temperature.

### Example 17

This example demonstrates the synthesis of polyoctene using a Hoveyda-Grubbs M720 initiator.

In a representative experiment, a solution of 11.8 mL of cis-cyclooctene in 180 mL of chloroform was added dropwise to a solution of 2.8 mg of Hoveyda-Grubbs M720 initiator in 3 mL of chloroform over 60 min.

Then, 100 mL of chloroform was added heat the solution was to 60° C. for 4 h. After that, 2.5 mL of ethyl vinyl ether were added all at once and the solution was stirred for 0.5 h at 40° C.

Then, the organic phase was extracted with 100 mL of an acidic solution HCl (10%) made with 81 mL of HCl (37%) in 219 mL DI water three times.

After the extractions, the organic solution was poured into 300 mL of isopropyl alcohol and a white polymer precipitated. Then, the liquid was decanted. The solid was collected and dried in a convection oven for 16 h at room temperature. (0.75 g, 7.5% yield). GPC (Mn=31.2 k Daltons, Mw=76.4 k Daltons, Ð=2.5).

### ASPECTS

In a first aspect, the disclosure provides a filter membrane comprising a polyolefin, wherein the sum of an amount of titanium, aluminum, iron, zinc and magnesium in the polyolefin is less than about 4 ppm, as determined by MARS 6 Microwave Acid Digestion Method Note Compendium.

In a second aspect, the disclosure provides the membrane of the first aspect, wherein the sum of the amount of titanium, aluminum, iron, zinc, and magnesium in the polyolefin is less than about 3.5 ppm.

In a third aspect, the disclosure provides the membrane of the first aspect, wherein the sum of the amount of titanium, aluminum, iron, zinc, and magnesium in the polyolefin is less than about 3 ppm.

In a fourth aspect, the disclosure provides the membrane of the first aspect, wherein the sum of the amount of titanium, aluminum, iron, zinc, and magnesium in the polyolefin is less than about 2 ppm.

In a fifth aspect, the disclosure provides the membrane of the first aspect, wherein the sum of the amount of titanium, aluminum, iron, zinc, and magnesium in the polyolefin is less than about 1 ppm.

In a sixth aspect, the disclosure provides the membrane of the first aspect, wherein the polyolefin has less than about 1 ppm of ruthenium, as determined by MARS 6 Microwave Acid Digestion Method Note Compendium.

In a seventh aspect, the disclosure provides the membrane of any one of the first through the sixth aspects, wherein the polyolefin is chosen from polyethylene and polyethylene-co-polybutylene.

In an eighth aspect, the disclosure provides the membrane of any one of the first through the sixth aspects, wherein the polyolefin is an ultra-high molecular weight polyethylene.

In a ninth aspect, the disclosure provides the membrane of any one of the first through the eighth aspects, wherein the polyolefin has a number average molecular weight of about 330,000 to 2,200,000 Daltons.

In a tenth aspect, the disclosure provides the membrane of any one of the first through the eighth aspects, wherein the polyolefin has a number average molecular weight of about 700,000 Daltons to about 1,500,000 Daltons.

In an eleventh aspect, the disclosure provides the membrane of the first aspect, wherein the polyolefin is prepared by:

A. contacting cis- or trans-cyclooctene with a Ru II catalyst, followed by

B. removal or extraction of the Ru II catalyst, followed by

C. hydrogenation with a hydrazine-type or hydrazido-type reducing agent.

In a twelfth aspect, the disclosure provides the membrane of the eleventh aspect, wherein the Ru II catalyst is chosen from:
i. (1,3-Bis(2,6-diisopropylphenyl)-4-((4-ethyl-4-methylpiperzain-1-ium-1-yl)methyl)imidazolidin-2-ylidene)(2-isopropoxybenzylidene)ruthenium(II) chloride dihydrate;
ii. (1,3-dimesityl-4-((trimethylammonio)methyl)imidazolidin-2-ylidene)dichloro(2-isopropoxybenzylidene)ruthenium(II) chloride;
iii. (4-((4-ethyl-4-methylpiperazin-1-ium-1-yl)methyl)-1,3-dimesitylimidazolidin-2-ylidene)dichloro(2-isopropoxybenzylidene)ruthenium(II) chloride;
iv. (1,3-dimesityl-4-((trimethylammonio)methyl)imidazolidin-2-ylidene)dichloro(2-isopropoxybenzylidene)ruthenium(II) hexafluorophosphate; and
v. (1,3-dimesityl-4-((trimethylammonio)methyl)imidazolidin-2-ylidene)dichloro(2-isopropoxybenzylidene)ruthenium(II) tetrafluoroborate.

In a thirteenth aspect, the disclosure provides the membrane of the first aspect, wherein the polyolefin is a polyethylene-co-polybutylene prepared by contacting polybutadiene with hydrogen in the presence of a hydrazido-type or hydrazine-type reducing agent.

In a fourteenth aspect, the disclosure provides a filter comprising a filter membrane comprising a polyolefin, wherein the sum of the amount of titanium, aluminum, iron, zinc and magnesium in the polyolefin is less than about 4 ppm, as determined by MARS 6 Microwave Acid Digestion Method Note Compendium.

In a fifteenth aspect, the disclosure provides a filter of the fourteenth aspect, wherein the sum of the amount of titanium, aluminum, iron, zinc, and magnesium in the polyolefin is less than about 3.5 ppm

In a sixteenth aspect, the disclosure provides a filter of the fourteenth aspect, wherein the sum of the amount of titanium, aluminum, iron, zinc, and magnesium in the polyolefin is less than about 3 ppm.

In a seventeenth aspect, the disclosure provides a filter of the fourteenth aspect, wherein the sum of the amount of titanium, aluminum, iron, zinc, and magnesium in the polyolefin is less than about 2 ppm.

In an eighteenth aspect, the disclosure provides a filter of the fourteenth aspect, wherein the sum of the amount of titanium, aluminum, iron, zinc, and magnesium in the polyolefin is less than about 1 ppm.

In a nineteenth aspect, the disclosure provides a filter of the fourteenth aspect, wherein the polyolefin has less than about 1 ppm of ruthenium, as determined by MARS 6 Microwave Acid Digestion Method Note Compendium.

In a twentieth aspect, the disclosure provides a filter of any one of the fourteenth through the eighteenth aspects, wherein the polyolefin is chosen from polyethylene and polyethylene-co-polybutylene.

In a twenty-first aspect, the disclosure provides a filter of any one of the fourteenth through the eighteenth aspects, wherein the polyolefin is an ultra-high molecular weight polyethylene.

In a twenty-second aspect, the disclosure provides a filter of any one of the fourteenth through the eighteenth aspects, wherein the polyolefin has a number average molecular weight of about 330,000 to 2,200,000 Daltons.

In a twenty-third aspect, the disclosure provides a filter of any one of the fourteenth through the eighteenth aspects, wherein the polyolefin has a number average molecular weight of about 700,000 Daltons to about 1,500,000 Daltons.

In a twenty-fourth aspect, the disclosure provides a method for removing an impurity from a liquid, which comprises contacting the liquid with the filter of any one of fourteenth through the twenty-third aspects.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A filter membrane comprising a polyolefin, wherein the sum of the amount of titanium, aluminum, iron, zinc and magnesium in the polyolefin is less than about 4 ppm, as determined by MARS 6 Microwave Acid Digestion Method Note Compendium.

2. The membrane of claim 1, wherein the sum of the amount of titanium, aluminum, iron, zinc, and magnesium in the polyolefin is less than about 3 ppm.

3. The membrane of claim 1, wherein the sum of the amount of titanium, aluminum, iron, zinc, and magnesium in the polyolefin is less than about 1 ppm.

4. The membrane of claim 1, wherein the polyolefin has less than about 1 ppm of ruthenium, as determined by MARS 6 Microwave Acid Digestion Method Note Compendium.

5. The membrane of claim 1, wherein the polyolefin is chosen from polyethylene and polyethylene-co-polybutylene.

6. The membrane of claim 1, wherein the polyolefin is an ultra-high molecular weight polyethylene.

7. The membrane of claim 1, wherein the polyolefin has a number average molecular weight of about 330,000 to 2,200,000 Daltons.

8. The membrane of claim 1, wherein the polyolefin has a number average molecular weight of about 700,000 Daltons to about 1,500,000 Daltons.

9. The membrane of claim 1, wherein the polyolefin is prepared by:
A. contacting cis- or trans-cyclooctene with a Ru II catalyst, followed by
B. removal or extraction of the Ru II catalyst, followed by
C. hydrogenation with a hydrazine-type or hydrazido-type reducing agent.

10. The membrane of claim 9, wherein the Ru II catalyst is chosen from
i. (1,3-Bis(2,6-diisopropylphenyl)-4-((4-ethyl-4-methylpiperzain-1-ium-1-yl)methyl)imidazolidin-2-ylidene)(2-isopropoxybenzylidene)ruthenium(II) chloride dihydrate;
ii. (1,3-dimesityl-4-((trimethylammonio)methyl)imidazolidin-2-ylidene)dichloro(2-isopropoxybenzylidene)ruthenium(II) chloride;
iii. (4-((4-ethyl-4-methylpiperazin-1-ium-1-yl)methyl)-1,3-dimesitylimidazolidin-2-ylidene)dichloro(2-isopropoxybenzylidene)ruthenium(H) chloride;
iv. (1,3-dimesityl-4-((trimethylammonio)methyl)imidazolidin-2-ylidene)dichloro(2-isopropoxybenzylidene)ruthenium(II) hexafluorophosphate; and
v. (1,3-dimesityl-4-((trimethylammonio)methyl)imidazolidin-2-ylidene)dichloro(2-isopropoxybenzylidene)ruthenium(II) tetrafluoroborate.

11. The membrane of claim 1, wherein the polyolefin is a polyethylene-co-polybutylene by contacting polybutadiene with hydrogen in the presence of a hydrazido-type or hydrazine-type reducing agent.

12. A filter comprising a filter membrane comprising a polyolefin, wherein the sum of the amount of titanium, aluminum, iron, zinc and magnesium in the polyolefin is less than about 4 ppm, as determined by MARS 6 Microwave Acid Digestion Method Note Compendium.

13. The filter of claim 12, wherein the sum of the amount of titanium, aluminum, iron, zinc, and magnesium in the polyolefin is less than about 3 ppm.

14. The filter of claim 12, wherein the sum of the amount of titanium, aluminum, iron, zinc, and magnesium in the polyolefin is less than about 1 ppm.

15. The filter of claim 12, wherein the polyolefin has less than about 1 ppm of ruthenium, as determined by MARS 6 Microwave Acid Digestion Method Note Compendium.

16. The filter of claim 12, wherein the polyolefin is chosen from polyethylene and polyethylene-co-polybutylene.

17. The filter of claim 12, wherein the polyolefin is an ultra-high molecular weight polyethylene.

18. The filter of claim 12, wherein the polyolefin has a number average molecular weight of about 330,000 to 2,200,000 Daltons.

19. The filter of claim 12, wherein the polyolefin has a number average molecular weight of about 700,000 Daltons to about 1,500,000 Daltons.

20. A method for removing an impurity from a liquid, which comprises contacting the liquid with the filter of claim 12.
